(19) United States
(12) Patent Application Publication
(10) Pub. No.: US 2019/0039557 A1
(43) Pub. Date: Feb. 7, 2019

(54) AIRBAG CUSHION WITH INTERNAL VALVE FOR SECONDARY PRESSURE CHAMBER

(71) Applicant: GM Global Technology Operations LLC, Detroit, MI (US)

(72) Inventors: William J. BARNES, Waterford, MI (US); Kenneth M. Zawisa, Brighton, MI (US)

(21) Appl. No.: 15/665,736

(22) Filed: Aug. 1, 2017

(51) Int. Cl. B60R 21/26; B60R 21/205; B60R 21/231

(52) U.S. Cl. CPC B60R 21/26; B60R 2021/0004; B60R 21/231; B60R 21/205

(57) ABSTRACT

An airbag cushion includes a first cushion portion including a first wall defining a first chamber and a second cushion portion connected to the first cushion portion and projecting outward therefrom. The second cushion portion includes a second wall defining a second chamber. The airbag cushion further includes a flow-restricting valve fluidly connecting the first chamber to the second chamber and configured to maintain a pressure level of gas inside the second chamber at a first pressure greater than a pressure level of gas inside the first chamber during a collision event.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to airbag cushions with a valve between a primary chamber and a secondary chamber. Airbag cushions are triggered and deployed during collision events. Airbag cushions can be positioned in vehicle cabins between occupants and rigid structures to absorb energy during a collision.

A chamber of an airbag cushion fills with gas during a collision event to absorb energy. The airbag cushions are designed to quickly inflate after a collision event is sensed and then deflate before or at the same time that a vehicle occupant contacts the airbag cushion. Contact by the vehicle occupant drives gas out of the airbag through vents or other relief features to absorb energy.

In small vehicles or in vehicles that have sharply angled windshields or include structures in close proximity to a vehicle occupant, there is less space in which to deploy an airbag cushion and less space in which to absorb the energy associated with a collision event.

### SUMMARY

An airbag cushion according to the present disclosure includes a first cushion portion including a first wall defining a first chamber and an outer surface with a port permitting flow of gas out of the first chamber and a second cushion portion connected to the first cushion portion and projecting outward therefrom. The second cushion portion includes a connection edge surrounding the port and a second wall defining a second chamber configured to receive gas from the first chamber through the port. The airbag cushion also includes a flow-restricting valve disposed at the port that is movable from an open position to a restricting position wherein the flow-restricting valve permits flow of gas from the first chamber to the second chamber through the port when the flow-restricting valve is in the open position and the flow-restricting valve restricts the flow of gas from the second chamber to the first chamber through the port when the flow-restricting valve is in the restricting position.

In one aspect, the flow-restricting valve includes a flap connected to the outer surface of the first cushion portion adjacent the port such that the flap extends over the port.

In one aspect, the flap is stitched to the first cushion portion at two regions on opposite sides of the port.

In one aspect, a portion of the flap between the two regions is configured to move relative to the outer surface of the first cushion portion. The portion is configured to be spaced apart from the outer surface of the first cushion portion by a gap when the flow-restricting valve is in the open position and the portion is configured to contact the outer surface of the first cushion portion at the port when the flow-restricting valve is in the restricting position.

In one aspect, the connection edge of the second cushion portion surrounds the flap.

In one aspect, the flow-restricting valve includes an elongated tether with a first end and a second end. The first end is connected to the first cushion portion adjacent the port and the second end is connected to the second cushion portion. The second end of the tether is configured to move away from the first end and to reduce a size of the port when the flow-restricting valve moves from the open position to the restricting position.

In one aspect, the port has a first diameter in the open position and a second diameter in the restricting position. The first diameter is less than the second diameter.

In one aspect, the tether is a drawstring that cinches the port from the first diameter to the second diameter when the second end moves away from the first end.

In one aspect, the tether is located in the second chamber.

In one aspect, a portion of the tether between the first end and the second end is secured around a periphery of the port.

In one aspect, a portion of the tether is disposed inside a track connected to a periphery around the port when the flow-restricting valve is in the open position. When the flow-restricting valve is moved to the restricting position, a part of the portion of the tether is pulled out of the track when the first end of the tether moves away from the second end to cinch the port from the first diameter to the second diameter.

In one aspect, the flow-restricting valve includes a valve wall defining an elongated passageway between a base and an outlet. The base is connected to the outer surface of the first cushion portion around the port.

In one aspect, the elongated passageway has a funnel shape.

In one aspect, the outlet is disposed inside the second chamber.

In one aspect, when the flow-restricting valve is in the open position, the elongated passageway extends from the port and into the second chamber, thereby permitting gas to flow from the first chamber through the elongated passageway and into the second chamber.

In one aspect, the valve wall between the base and the outlet is configured to deform in response to an external force applied to the valve wall such that a size of the elongated passageway is reduced.

Another airbag cushion in accordance with the present disclosure includes a first cushion portion including a first wall defining a first chamber and a second cushion portion connected to the first cushion portion and projecting outward therefrom. The second cushion portion includes a second wall defining a second chamber. The airbag cushion further includes a flow-restricting valve fluidly connecting the first chamber to the second chamber and configured to maintain a pressure level of gas inside the second chamber at a first pressure greater than a pressure level of gas inside the first chamber during a collision event.

In one aspect, the flow-restricting valve is configured to maintain the pressure level of gas inside the second chamber at the first pressure in response to the pressure level of gas inside the first chamber exceeding a second pressure.

In one aspect, the flow-restricting valve is configured to maintain the pressure level of gas inside the second chamber at the first pressure in response to the pressure level of gas inside the second chamber exceeding a second pressure.

In one aspect, the flow-restricting valve is configured to maintain the pressure level of gas inside the second chamber at the first pressure in response to an external force applied to the second wall.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an illustration of an example vehicle occupant safety system including an example airbag cushion according to the present disclosure;

FIG. 2 is a top view of the example airbag cushion of FIG. 1;

FIG. 3 is an illustration of an example flow-restricting valve according to the present disclosure;

FIG. 4 is a cross-sectional view of the example flow-restricting valve of FIG. 3 in an open position;

FIG. 5 is a cross-sectional view of the example flow-restricting valve of FIG. 3 in a restricting position;

FIG. 6 is an illustration of another example flow-restricting valve in an open position according to the present disclosure;

FIG. 7 is an illustration of the example flow-restricting valve of FIG. 6 in a restricting position;

FIG. 8 is an illustration of another example flow-restricting valve in an open position according to the present disclosure; and

FIG. 9 is an illustration of the example flow-restricting valve of FIG. 8 in a restricting position.

In the drawings, reference numbers may be reused to identify similar and/or identical elements.

### DETAILED DESCRIPTION

One way of protecting a vehicle occupant from contacting a rigid structure that is located in close proximity to a vehicle occupant is to provide an additional airbag cushion in the path of the vehicle occupant after a collision event occurs. Different types of airbag cushions may be desirable, however, for different types of collisions. For example, an airbag cushion that inflates from an instrument panel may be suitable to protect a vehicle occupant during a head-on collision due to ample space between the occupant and the windshield. However, a different type of airbag cushion may be desirable during an offset collision since the vehicle occupant moves sideways in addition to moving forward.

The additional airbag cushion that may be provided in such instances, however, may need to be maintained at a different pressure than existing airbag cushions because there is less room between the vehicle occupant and the rigid structure. It also may be desirable to maintain the additional airbag cushion at a different pressure than existing airbag cushions because existing airbag cushions begin to deflate quickly after inflation and do not maintain a desired position in the path of the vehicle occupant. The additional airbag cushion may need to be maintained at a higher pressure or be restricted from rapidly deflating to increase the stiffness of the airbag cushion and thereby reduce the likelihood that the vehicle occupant contacts the rigid structure.

The airbag cushion of the present disclosure includes a flow-restricting valve located between a primary pressure chamber and a supplemental pressure chamber. The supplemental pressure chamber projects outward from the primary pressure chamber to reduce the likelihood that a vehicle occupant contacts a rigid structure in a vehicle cabin. Traditional airbag cushions typically include a single, primary pressure chamber with vents for quickly deflating the primary pressure chamber. The airbag cushion of the present disclosure restricts the rapid deflation that occurs in typical airbag cushions and thereby maintains a higher pressure in the supplemental airbag cushion.

The airbag cushion and flow-restricting valve of the present disclosure permits gas to flow from the primary pressure chamber to the supplemental pressure chamber during the inflation of the airbag cushion so that both chambers are adequately inflated. Upon reaching sufficient deployment pressure and position, the flow-restricting valve restricts flow of the gas from the supplemental pressure chamber back to the primary pressure chamber in order to maintain the supplemental pressure chamber at an adequate pressure. The flow-restricting valve restricts the flow of gas out of the supplemental pressure chamber so that the supplemental pressure chamber does not deflate as rapidly as the primary chamber. In this manner, the supplemental pressure chamber remains more inflated than the primary pressure chamber so that the supplemental airbag cushion maintains a desired position in the vehicle cabin.

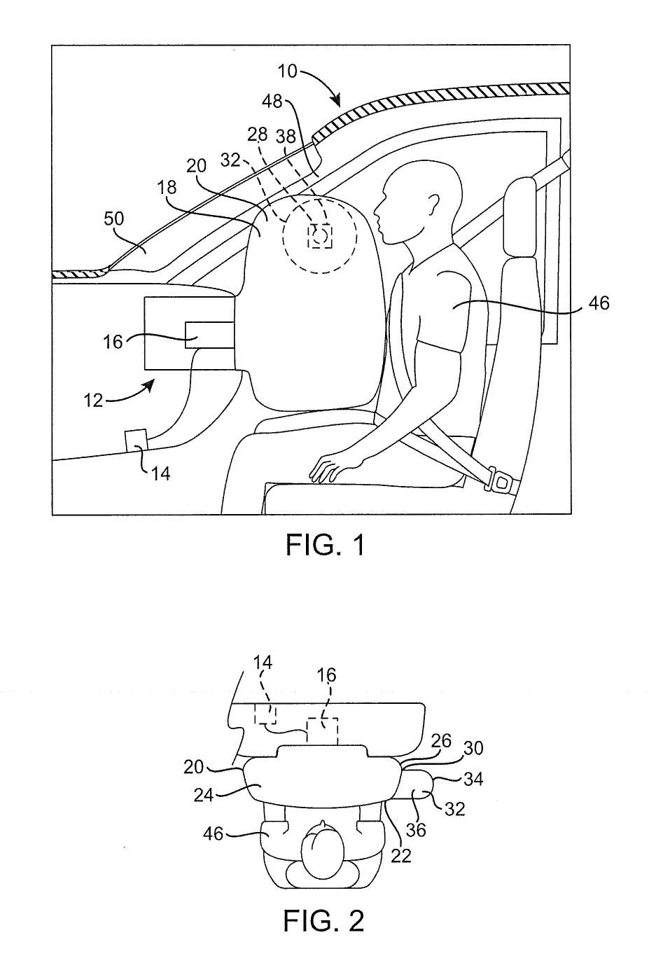

FIG. 1 shows a vehicle 10 including a vehicle occupant safety system 12. The vehicle occupant safety system 12 includes a collision module 14, an inflator 16 and an airbag cushion 18. The collision module 14 is connected to the inflator 16 that is, in turn, connected to the airbag cushion 18. The collision module 14 is also connected to a collision sensor (not shown). The collision sensor collects and transmits information to the collision module 14 during the operation of the vehicle. The information collected and transmitted to the collision module 14 may include speed data, acceleration data, force data, angular position data and the like. This information is compared to pre-determined thresholds or other collision characteristics by the collision module 14 to determine whether a collision event has occurred. Example collision sensors include accelerometers, gyroscopes, pressure sensors, speed sensors or the like. When the collision module 14 determines that the vehicle 10 is involved in a collision event, the collision module 14 sends a signal to the inflator 16 to deploy the airbag cushion 18.

Upon the determination that a collision event has occurred, the inflator 16 is triggered to inflate the airbag cushion 18. Any suitable inflator may be used such as pyrotechnic or stored gas inflators. The inflator 16 rapidly inflates the airbag cushion 18 with a gas and the airbag cushion rapidly expands to create a barrier between a vehicle occupant and the rigid structures in the vehicle 10.

As shown in FIG. 1, the airbag cushion 18 includes a primary or first cushion portion 20 as well as a supplemental or second cushion portion 32. In other examples, the airbag cushion 18 can include other supplemental cushion portions as may be desired to add additional or alternative protections to an occupant 40.

In the example illustrated, the airbag cushion 18 includes the second cushion portion 32 in order to prevent the occupant 40 from contacting an A-pillar 42. As previously described, the A-pillar 42 and/or a windshield 44 may be angled toward the occupant 40 such that traditional airbag cushions are less likely to prevent the occupant 40 from contacting the A-pillar 42 or the windshield 44 during a collision event. To address these circumstances, the airbag cushion 18 includes the second cushion portion 32 that projects outward from the first cushion portion 20 between the occupant 40 and an area such as, the A-pillar 42. Other examples include supplemental cushions that are used to protect occupants from contacting formations on instrument panels such as navigation screens, raised or recessed storage compartments, user interfaces, entertainment systems, climate control system components and the like.

Referring back to FIG. 1, the occupant 40 is a front seat passenger in the vehicle 10. The airbag cushion 18 is an airbag located in front of the occupant 40 and is shown as it would appear after the inflator 16 has inflated the airbag cushion 18. As can be appreciated, the airbag cushion 18 can be used in other locations in the vehicle as well. As shown in FIG. 2, the first cushion portion 20 is located substantially in front of the occupant 40 and projects laterally across the vehicle 10 from a center region of the vehicle 10 towards the outboard side of the vehicle 10. The second cushion portion 32 projects outward from a lateral outer surface 26 located on the outboard side of the first cushion portion 20. In this example, the second cushion portion 32 is disposed in front of and laterally outboard of the occupant 40. In this position, the second cushion portion 32 is located in a path of travel if occupant were to move forward and outboard during a collision event. In other examples, the second cushion portion 32 can have other orientations and project in different directions in the vehicle 10. For example, the second cushion portion 32 can project inward toward a driver's seat, project upward toward the roof, project downward toward an occupant's feet or project in any direction where further protections are needed.

Referring again to FIGS. 1 and 2, the first cushion portion 20 includes a first wall 22 that defines a first chamber 24. The first wall 22 is a thin layer of material that is stitched or otherwise formed into a rounded shape to create the first chamber 24. The first chamber 24 is an enclosed volume that is capable of holding the gas emitted by the inflator 16. The first wall 22 of the first cushion portion 20 defines a port 28. The port 28 is an opening in the first wall 22 that permits gas to flow out of the first chamber 24. In this example, the port 28 is a single circular opening but other shapes of the port 28 or multiple openings can also be used.

The second cushion portion 32 includes a second wall 34 that defines a second chamber 36. The second wall 34 is also a thin layer of material stitched or otherwise formed into a rounded shape. The second cushion portion 32 includes a connection edge 30 that is joined to the outer surface 26 of the first cushion portion 20. In this example, the connection edge 30 is substantially circular in shape but the connection edge 30 can be rectangular, oval or other suitable shape. The connection edge 30 is an edge of the second wall 34 that is joined to the second cushion portion 32 around the port 28. In this configuration, gas located in the first chamber 24 can flow through the port 28 into the second chamber 36.

As further shown in this example on FIG. 1, the airbag cushion 18 also includes a flow-restricting valve 38. The flow-restricting valve 38 is located at or near the port 28. In certain modes of operation, the flow-restricting valve 38 restricts the flow of gas from the second chamber 36 to the first chamber 24. As previously described, it is desirable to maintain a pressure level in the second chamber 36 above a predetermined threshold in order to maintain a desired orientation or a desired stiffness of the second cushion portion 32. One way of maintaining a desired orientation or a desired stiffness is to ensure that gas does not freely flow back into the first chamber 24 from the second chamber 36. The flow-restricting valve 38 is positioned at or near the port 28 in order to restrict such free flow.

The flow-restricting valve 38 is configured to operate in an open position and in a restricting position. In the open position, the flow-restricting valve 38 permits the flow of gas from the first chamber 24 into the second chamber 36. The flow-restricting valve 38 operates in the open position during the inflation stage of the airbag cushion 18. In the restricting position, the flow-restricting valve 38 serves to restrict flow of gas from the second chamber 36 into the first chamber 24. The flow-restricting valve 38 operates in the restricting position after the second cushion portion 32 has been deployed and is positioned in its desired position. The flow-restricting valve 38 in its restricting position serves to maintain the second cushion portion 32 in this desired position. Flow-restricting valve may have various suitable configurations in order to provide this functionality.

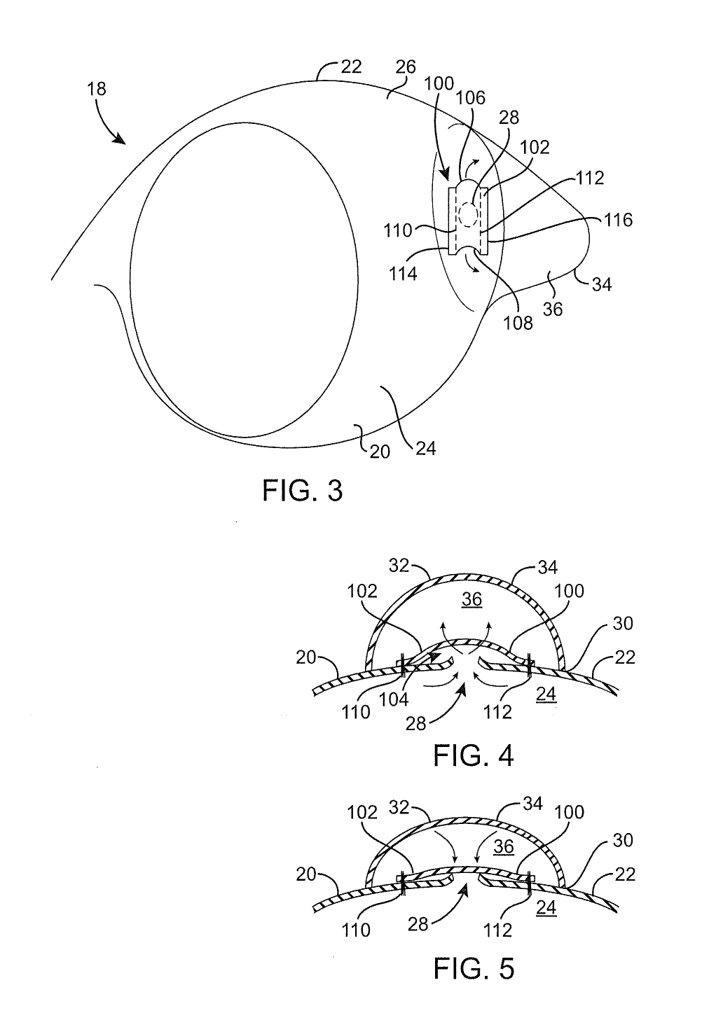

In one example embodiment shown in FIG. 3, the airbag cushion 18 includes a flow-restricting valve 100. In this example, the flow-restricting valve 100 includes a flap 102 that is positioned over the port 28. The flap 102 is a thin piece of material that is connected on at least one side of the port 28 such that when the first cushion portion 20 is filled with gas and the second cushion portion 32 is filled with gas, the flap 102 covers the port 28. In the example shown in FIG. 3, the flap 102 is rectangular in shape and the flap 102 is stitched on two regions of the flap 102 that are located on opposing sides of the port 28. A first row of stitches 110 and a second row of stitches 112 are vertically positioned on opposite sides of the port 28. The first row of stitches 110 are substantially parallel to a first side edge 114 of the flap 102 and the second row of stitches 112 are substantially parallel to a second side edge 116 of the flap 102. A top edge 106 and a bottom edge 108 of the flap 102 are left unsecured and are able to separate from the outer surface 26 of the first cushion portion during inflation of the first chamber 24 and the second chamber 36. In other examples, the flap 102 can have other shapes and can be joined to the first cushion portion by other suitable joining techniques such as adhesive, welding, staking or the like. The flap 102 can be constructed of any suitable material and in one example, is made of a woven nylon fabric.

The flow-restricting valve 100 is shown in the open position in FIG. 4 and in the restricting position in FIG. 5. As shown, the flap 102 is separated from the outer surface 26 of the first cushion portion 20 by a gap 104. When the first chamber 24 is filling with gas from the inflator 16, the flow-restricting valve 100 is in the open position because the pressure inside the first chamber 24 is not exerting forces on the first wall 22 to tension the outer surface 26. This circumstance permits the region of the flap 102 between the first row of stitches 110 and the second row of stitches 112 to separate from the outer surface 26 and to permit the flow of gas from the first chamber 24 to the second chamber 36. As the first chamber 24 fills with gas and pressure inside the first chamber 24 rises, forces are exerted against the inside of the first wall 22. This action effectively tensions the first wall 22 and moves the first row of stitches 110 further away from the second row of stitches 112. As this occurs, the gap 104 is reduced and the region of the flap 102 between the first row of stitches 110 and the second row of stitches 112 is pulled closer to the port 28.

The flap 102 is connected to the first wall 22 so that when the first chamber 24 is fully inflated (in the range of 30 to 40 psi, for example) the flap 102 lies flat along the outer surface 26 of the first wall 22. This can be accomplished by stitching the flap 102 such that the distance between the first row of stitches 110 and the second row of stitches 112 along the first wall 22 is substantially the same as the length of the material of the flap 102 between the location of the first row of stitches 110 and the second row of stitches 112. As can be appreciated, if the distance between the first row of stitches 110 and the second of stitches 112 along the first wall 22 is less than the length of material of the flap 102 between the first row of stitches 110 and the second row of stitches 112, the flap 102 would remain puckered even when the first chamber 24 is fully inflated.

The foregoing configuration of the flap 102 relative to the first wall 22 enables the flap 102 to permit the flow of gas from the first chamber 24 into the second chamber 36 when the flow-restricting valve 100 is in the open position (i.e., the flap 102 is separated from the first wall 22). When the flow-restricting valve 100 is in the restricting position (i.e., the flap 102 is pulled closer to the first wall 22), the flow of gas from the second chamber 36 to the first chamber 24 is restricted and the pressure in the second chamber 36 can be kept at a higher pressure level than a pressure level in the first chamber 24.

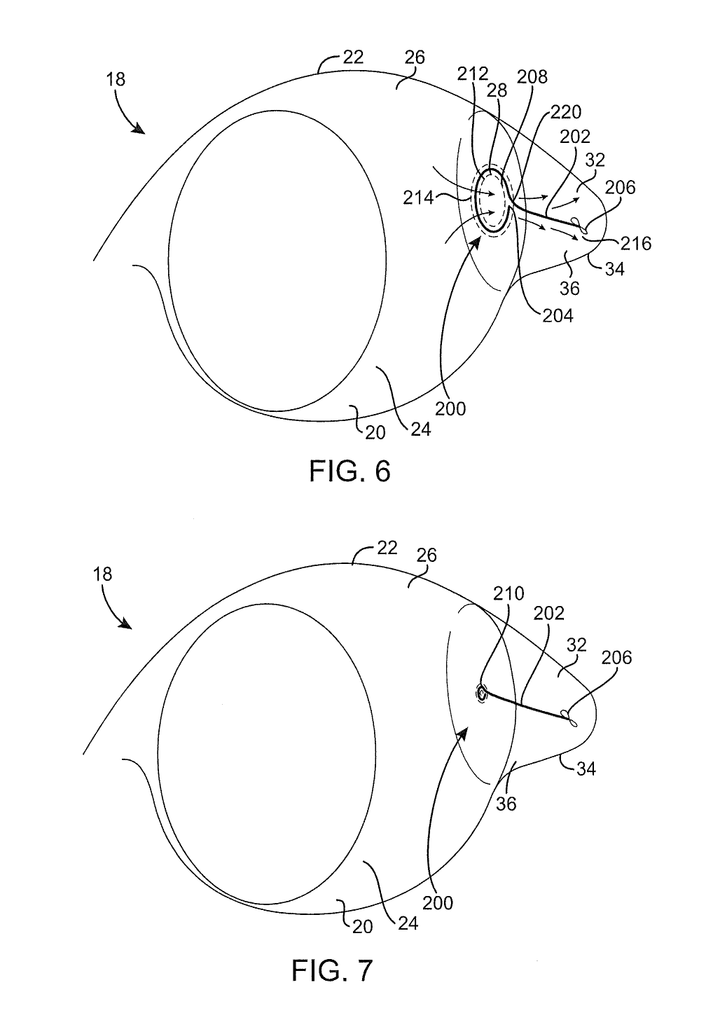

FIGS. 6 and 7 show a flow-restricting valve 200. In this example, the flow-restricting valve 200 includes a tether 202 and a track 214. The tether 202 is an elongated component with a first end 204 attached to the first cushion portion 20 at or near a periphery 212 of the port 28. The first end 204 of the tether 202 can be attached to the first cushion portion 20 by stitches, adhesive, staking or any other suitable method. A second end 206 of the tether 202 is attached to an inner wall 216 of the second cushion portion 32. The second end 206 is also attached via stitches, adhesive, staking or any other suitable method. A portion 218 of the tether 202 between the first end 204 and the second end 206 is attached or secured around the port 28. As shown in FIG. 6, the portion 218 of the tether 202 is located in the track 214. The portion 218 of the tether 202 in the track 214 extends from the first end 204 and circles around the port 28 in a clock-wise direction before exiting the track 214 at point 220. In this example, a thin piece of material is stitched or otherwise joined to the first wall 22 of the first cushion portion 20 around the port 28 to create the track 214. The track 214 is a channel through which the tether can be routed to encircle the port 28. As can be appreciated, when the second end 206 is extended away from the first end 204, the tether 202 acts as a drawstring and cinches the track 214 together to reduce the diameter of the port 28.

FIG. 6 shows the flow-restricting valve 200 in the open position. As previously described, during the inflation stage of the airbag cushion 18, gas is filling the first chamber 24 and is flowing through the port 28 to fill the second chamber 36. During this stage of operation, the diameter of the port 28 is unobstructed by the flow-restricting valve 200. As the second chamber 36 fills with gas, the inner wall 216 of the second chamber 36 moves away from the first chamber 24 and the port 28. As this occurs, the second end 206 that is attached to the inner wall 216 also moves away from the port 28 and away from the first end 204 of the tether 202. This motion moves the flow-restricting valve 200 from the open position to the restricting position.

As shown in FIG. 7, the flow-restricting valve 200 is in the restricting position. During the movement of the inner wall 216 away from the port 28, the portion 218 of the tether 202 located in the track 214 has been reduced because the tether 202 has been pulled out of the track 214. This, in turn, reduces the diameter of the port 28 to a second diameter 210 since the track 214 has been cinched together. The second diameter 210 is less than an original or first diameter 208 shown in FIG. 6. Since the second diameter 210 is smaller than the first diameter 208, the flow of gas from the second chamber 36 back to the first chamber 24 is restricted by the flow-restricting valve 200.

The example of FIGS. 6 and 7 illustrates a drawstring and cinching motion. In other examples of the flow-restricting valve 200, the first end 204 of the tether 202 can be connected to other closing mechanisms that can reduce the size of the opening between the first chamber 24 and the second chamber 36. Such alternative closing mechanisms include a zipper, a sliding or hinged door or an iris-like device. As can be appreciated, the moving element of such alternative closing mechanism can be attached to the first end 204 of the tether 202 and moved from the open position to the restricting position when the second end 206 of the tether 202 is pulled away from the port 28 during the inflation of the second chamber 36.

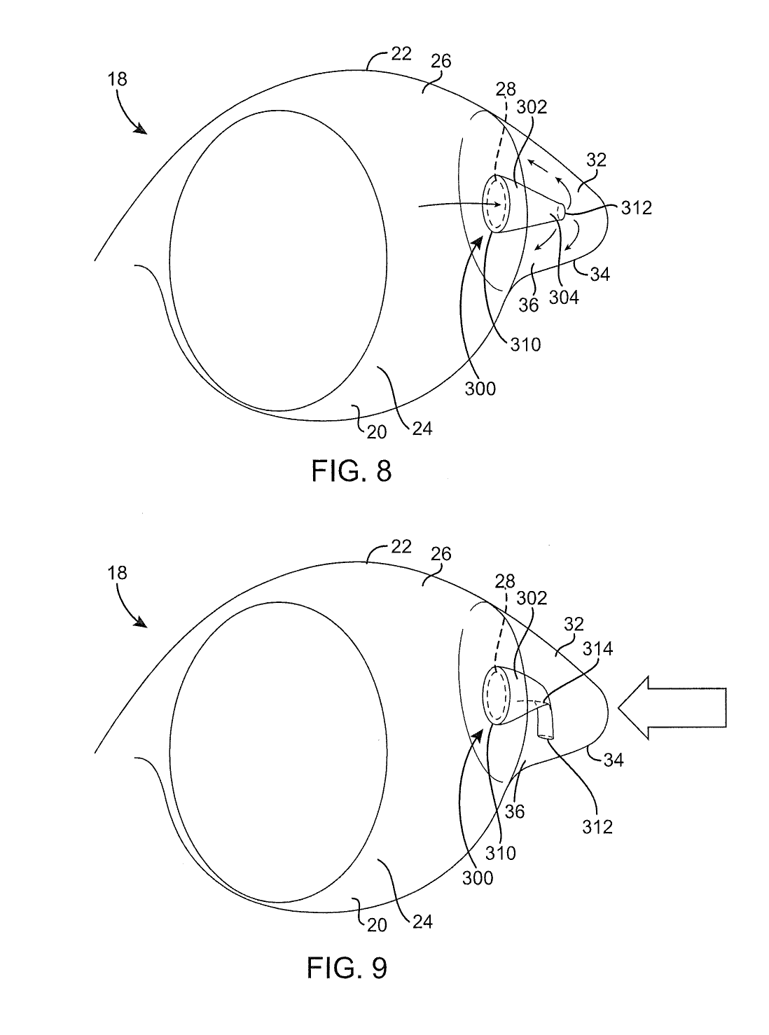

Another example embodiment of the flow-restricting valve is shown in FIGS. 8 and 9. In this example, a flow-restricting valve 300 includes a valve wall 302 that defines an elongated passageway 304. In this example, the valve wall 302 is frusto-conical in shape with a base 310 connected to the first cushion portion 20 around the port 28 and an outlet 312 that projects into the second chamber 36. The outlet 312 has a smaller diameter than the base 310 such that the flow-restricting valve 300 is funnel-shaped. The base 310 is connected to the first cushion portion 20 by any suitable attachment method such as, by stitching, adhesive, welding, staking or the like. The outlet 312 is a free end of the flow-restricting valve 300 and is disposed within the second chamber 36. The outlet 312 can bend or otherwise move inside of the second chamber 36. The flow-restricting valve 300 can be configured in other shapes besides the frusto-conical shape shown in FIG. 8. In other examples, the flow-restricting valve 300 is cylinder-shaped, pyramid-shaped, or has another elongated shape with a central passageway.

FIG. 8 shows the flow-restricting valve 300 in the open position. In this position, the first chamber 24 is filling with gas and the gas is then flowing through the port 28 into the second chamber 36 by passing through the elongated passageway 304 in the flow-restricting valve 300. During the inflation stage, the second chamber 36 fills with gas that causes the second cushion portion 32 to project away from the first cushion portion 20. In this configuration, gas can freely flow through the elongated passageway 304.

FIG. 9 shows the example flow-restricting valve 300 in the restricting position during a collision event. In this example, the flow-restricting valve 300 does not restrict the flow of gas until an occupant contacts the second cushion portion 32 as shown. During a collision event, the occupant 40 deforms the second cushion portion 32, which in turn deforms the valve wall 302 of the flow-restricting valve 300, thereby causing the flow-restricting valve 300 to assume the restricting position. The deformation of the valve wall 302 closes or reduces the size of the elongated passageway 304. The deformation of the valve wall 302 restricts the flow of gas from the second chamber to the first chamber 24 since the size of the elongated passageway is reduced.

As shown in FIG. 9, the occupant 40 contacts the second cushion portion 32 as indicated by the arrow and deforms the valve wall 302 of the flow-restricting valve 300 at a pinch point 314. The pinch point 314 is the location on the valve wall 302 where the elongated passageway 304 has been folded at a right angle to its original extended position shown in FIG. 8. As can be appreciated, the occupant 40 may contact the second cushion portion 32 in a variety of ways and from a variety of angles during a collision event. Due to the variety of ways that the occupant 40 may contact the second cushion portion 32, the valve wall 302 can be deformed in a variety of ways as well. For example, instead of the valve wall 302 being deformed by folding at a right angle, the valve wall 302 can be folded at a different angle. The valve wall 302 can be folded at a location closer to the outlet 312 or closer to the base 310 than as shown in FIG. 9, or the valve wall 302 may be squeezed closed during a collision event. Regardless of the location or type of deformation of the valve wall 302, when an occupant contacts the second cushion portion 32 and contacts the flow-restricting valve 300, the size of the elongated passageway 304 is reduced from its original size to restrict the flow of gas from the second chamber 36.

The foregoing examples of the flow-restricting valve operate in the open position during the inflation of the airbag cushion 18 and operate in the restricting position during a collision event. As previously described, the flow-restricting valve in the restricting position restricts the flow of air from the second chamber 36 back to the first chamber 24 that would otherwise occur in the absence of the flow-restricting valve. In this manner, the flow restricting valve maintains a pressure level inside of the second chamber 36 that is greater than a pressure level inside of the first chamber 24 during a collision event. The flow-restricting valve can also maintain the pressure level inside of the second chamber 36 above a predetermined threshold. The predetermined threshold of pressure inside of the second chamber 36 can be determined such that at or above the predetermined threshold pressure, the second cushion portion 32 is positioned in a desired location or orientation to protect a vehicle occupant. In one example, the predetermined threshold pressure is 10 psi. In other examples, the predetermined threshold can be other values in the range of 5 to 15 psi.

The foregoing examples describe primary (or first) cushion portions that are passenger side airbag cushions with supplemental (or second) cushion portions that project therefrom to provide protection to vehicle occupants. The first and second cushions can be located on the driver's side or elsewhere in a vehicle. Furthermore, the example flow-restricting valves previously described can be used in other locations in a vehicle as well.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

In this application including the definitions below the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. An airbag cushion comprising:
a first cushion portion including a first wall defining a first chamber and an outer surface with a port permitting flow of gas out of the first chamber;
a second cushion portion connected to the first cushion portion and projecting outward therefrom, the second cushion portion including a connection edge surrounding the port and a second wall defining a second chamber configured to receive gas from the first chamber through the port; and
a flow-restricting valve disposed at the port and movable from an open position to a restricting position wherein:
the flow-restricting valve permits flow of gas from the first chamber to the second chamber through the port when the flow-restricting valve is in the open position; and
the flow-restricting valve restricts the flow of gas from the second chamber to the first chamber through the port when the flow-restricting valve is in the restricting position.

2. The airbag cushion of claim 1 wherein the flow-restricting valve includes a flap connected to the outer surface of the first cushion portion adjacent the port such that the flap extends over the port.

3. The airbag cushion of claim 2 wherein the flap is stitched to the first cushion portion at two regions on opposite sides of the port.

4. The airbag cushion of claim 3 wherein:
a portion of the flap between the two regions is configured to move relative to the outer surface of the first cushion portion;
the portion is configured to be spaced apart from the outer surface of the first cushion portion by a gap when the flow-restricting valve is in the open position; and
the portion is configured to contact the outer surface of the first cushion portion at the port when the flow-restricting valve is in the restricting position.

5. The airbag cushion of claim 2 wherein the connection edge of the second cushion portion surrounds the flap.

6. The airbag cushion of claim 1 wherein:
the flow-restricting valve includes an elongated tether with a first end and a second end, the first end connected to the first cushion portion adjacent the port and the second end connected to the second cushion portion; and
the second end of the tether is configured to move away from the first end and to reduce a size of the port when the flow-restricting valve moves from the open position to the restricting position.

7. The airbag cushion of claim 6 wherein the port has a first diameter in the open position and a second diameter in the restricting position, the first diameter being less than the second diameter.

8. The airbag cushion of claim 7 wherein the tether is a drawstring that cinches the port from the first diameter to the second diameter when the second end moves away from the first end.

9. The airbag cushion of claim 8 wherein the tether is located in the second chamber.

10. The airbag cushion of claim 8 wherein a portion of the tether between the first end and the second end is secured around a periphery of the port.

11. The airbag cushion of claim 8 wherein:
a portion of the tether is disposed inside a track connected to a periphery around the port when the flow-restricting valve is in the open position; and
when the flow-restricting valve is moved to the restricting position, a part of the portion of the tether is pulled out of the track when the first end of the tether moves away from the second end to cinch the port from the first diameter to the second diameter.

12. The airbag cushion of claim 1 wherein the flow-restricting valve includes a valve wall defining an elongated passageway between a base and an outlet, and the base is connected to the outer surface of the first cushion portion around the port.

13. The airbag cushion of claim 12 wherein the elongated passageway has a funnel shape.

14. The airbag cushion of claim 12 wherein the outlet is disposed inside the second chamber.

15. The airbag cushion of claim 12 wherein, when the flow-restricting valve is in the open position, the elongated passageway extends from the port and into the second chamber, thereby permitting gas to flow from the first chamber through the elongated passageway and into the second chamber.

16. The airbag cushion of claim 15 wherein the valve wall between the base and the outlet is configured to deform in response to an external force applied to the valve wall such that a size of the elongated passageway is reduced.

17. An airbag cushion comprising:
a first cushion portion including a first wall defining a first chamber;
a second cushion portion connected to the first cushion portion and projecting outward therefrom, the second cushion portion including a second wall defining a second chamber; and
a flow-restricting valve fluidly connecting the first chamber to the second chamber and configured to maintain a pressure level of gas inside the second chamber at a first pressure greater than a pressure level of gas inside the first chamber during a collision event.

18. The airbag cushion of claim 17 wherein the flow-restricting valve is configured to maintain the pressure level of gas inside the second chamber at the first pressure in response to the pressure level of gas inside the first chamber exceeding a second pressure.

19. The airbag cushion of claim 17 wherein the flow-restricting valve is configured to maintain the pressure level of gas inside the second chamber at the first pressure in response to the pressure level of gas inside the second chamber exceeding a second pressure.

20. The airbag cushion of claim 17 wherein the flow-restricting valve is configured to maintain the pressure level of gas inside the second chamber at the first pressure in response to an external force applied to the second wall.
